(19) United States
(12) Patent Application Publication
(10) Pub. No.: US 2020/0096423 A1
(43) Pub. Date: Mar. 26, 2020

(54) SAMPLE TRANSFER DEVICE

(71) Applicant: Shimadzu Corporation, Kyoto (JP)

(72) Inventor: Yuki KOMORI, Kyoto (JP)

(21) Appl. No.: 16/560,157

(22) Filed: Sep. 4, 2019

(30) Foreign Application Priority Data
Sep. 26, 2018 (JP) 2018-180538

(51) Int. Cl. G01N 1/24; G01N 35/04; G01N 1/14

(52) U.S. Cl. CPC G01N 1/24; G01N 2001/002; G01N 1/14; G01N 35/04

(57) ABSTRACT

This sample transfer device is provided with a negative pressure supply unit configured to supply negative pressure, a sample container holding unit configured to hold a sample container by suctioning the sample container by the negative pressure supplied in a state of being in contact with the sample container, a sample suction and discharge unit configured to suction the sample from the sample container and discharge the sample at a predetermined position, and a horizontal direction moving mechanism configured to integrally move the sample container holding unit together with the sample suction and discharge unit in a horizontal direction.

### CROSS-REFERENCE TO THE RELATED APPLICATIONS

The priority application number JP2018-180538, entitled “SAMPLE TRANSFER DEVICE”, filed on Sep. 26, 2018 and invented by Yuki Komori, upon which this patent application is based is hereby incorporated by reference.

### BACKGROUND OF THE INVENTION

### Field of the Invention

The present invention relates to a sample transfer device, and more particularly to a sample transfer device for transferring a sample container containing a sample.

### Description of the Background Art

Conventionally, a sample transfer device for transferring a sample container containing a sample is known. Such sample transfer device is disclosed, for example, in Japanese Unexamined Patent Application Publication No. 2016-203309.

The sample transfer device disclosed in Japanese Unexamined Patent Application Publication No. 2016-203309 is configured to transfer a sample container by a sample container holding unit capable of moving in a horizontal direction and in a vertical direction. The sample container holding unit disclosed in Japanese Unexamined Patent Application Publication No. 2016-203309 is provided with a gripping portion for gripping the sample container, and transfers the sample container in the state of gripping the sample container by the gripping portion.

Here, the sample transfer device disclosed in Japanese Unexamined Patent Application Publication No. 2016-203309 is sometimes used together with an auto-sampler that injects a sample into an analysis device for analyzing the sample disclosed in Japanese Unexamined Patent Application Publication No. H7-270429 to automate the analysis of the sample.

The auto-sampler disclosed in Japanese Unexamined Patent Application Publication No. H7-270429 is configured to arrange a needle at a position where the sample container is arranged by moving the needle in the horizontal direction and in the vertical direction, and suctions the sample. Further, the auto-sampler disclosed in Japanese Unexamined Patent Application Publication No. H7-270429 is configured to move the needle to the sample inlet port of the analysis device and discharge the suctioned sample.

Here, in cases where the sample transfer device disclosed in Japanese Unexamined Patent Application Publication No. 2016-203309 and the auto-sampler disclosed in Japanese Unexamined Patent Application Publication No. H7-270429 are used together to perform the transferring of the sample to be analyzed and the processing of injecting the sample into the analysis device, since each of the sample transfer device and the auto-sampler has a mechanism for moving the sample container holding unit and a mechanism for moving the needle, there is an inconvenience that the size of the device increases.

Under the circumstance, conventionally, a sample transfer device capable of suppressing an increase in the size of the device is proposed in Japanese Unexamined Patent Application Publication No. 2015-197444. The sample transfer device disclosed in Japanese Unexamined Patent Application Publication No. 2015-197444 is configured to obtain a sample by piercing a collector provided on a rod-like support member into a sample container. Further, in Japanese Unexamined Patent Application Publication No. 2015-197444, a configuration is disclosed in which a sample container is held and transferred by engaging an engaged portion provided at a lid portion of the sample container and an engaging portion provided at a position opposite to a rod-like supporting member. That is, in the configuration disclosed in Japanese Unexamined Patent Application Publication No. 2015-197444, the collector for acquiring the sample and the engaging portion for holding the sample are configured to be movable by the same moving mechanism. Therefore, since it is not necessary to separately provide a mechanism for moving the needle and a mechanism for moving the sample container holding unit, it is possible to suppress the enlargement of the device.

However, in the configuration disclosed in Japanese Unexamined Patent Application Publication No. 2015-197444, there is an inconvenience that it is necessary to provide a dedicated engaged portion to be engaged with the engaging portion in the lid portion of the sample container. Moreover, since the holding of the sample container is performed by the engagement between the engaging portion and the engaged portion, when releasing the holding of the sample container at a predetermined position after transferring, there is an inconvenience that it is required to fix the sample container (lid portion) in order to release the engagement between the engaging portion and the engaged portion. Therefore, in the configuration disclosed in Japanese Unexamined Patent Application Publication No. 2015-197444, there is a problem that it is necessary to replace the lid portion of the sample container with an exclusively designed lid portion and a mechanism for fixing the sample container is separately required at the position where the holding of the sample container is released.

The present invention has been made to solve the aforementioned problems, and one object of the present invention is to provide a sample transfer device capable of suppressing an increase in size of a device and capable of transferring a sample container without using an exclusively designed sample container and a mechanism for fixing a sample container.

### SUMMARY OF THE INVENTION

In order to attain the above object, the sample transfer device according to one aspect of the present invention includes: a negative pressure supply unit configured to supply negative pressure; a sample container holding unit configured to hold a sample container by suctioning the sample container by the negative pressure supplied in a state of being in contact with the sample container; a sample suction and discharge unit configured to suction a sample from the sample container and discharge the sample at a predetermined position; and a horizontal direction moving mechanism configured to integrally move the sample container holder together with the sample suction and discharge unit in a horizontal direction.

The sample transfer device according to one aspect of the present invention includes, as described above, a sample container holding unit configured to hold a sample container by suctioning the sample container by the negative pressure, a sample suction and discharge unit, and a horizontal direction moving mechanism configured to integrally move the sample container holding unit together with the sample suction and discharge unit.

With this, the sample container holding unit and the sample suction and discharge unit can be integrally moved in the horizontal direction by a single horizontal direction moving mechanism. As a result, it is possible to suppress an increase in the size of the device, as compared with the case where a moving mechanism for moving the sample container holding unit and a moving mechanism for moving the sample suction and discharge unit in the horizontal direction are separately provided. Further, it becomes possible to hold the sample container by suctioning the sample container by negative pressure, and therefore, unlike the case where the sample container is held by the engagement between the engaging portion and the engaged portion, it is not necessary to replace the sample container having a dedicated structure. Further, since it becomes possible to release the holding of the sample container by stopping the supply of the negative pressure, for example, as compared with the mechanism for holding the sample container by the engagement between the engaging portion and the engaged portion or by the magnet, etc., when releasing the holding of the sample container, there is no need to provide a mechanism or the like for fixing the sample container, so that the device configuration can be simplified. In addition, since the holding force can be adjusted by controlling the supply amount of the negative pressure, it is possible to appropriately change the holding force depending on the type, etc., of the sample container. Therefore, for example, as compared with a mechanism for holding the sample container by the engagement between the engaging portion and the engaged portion or by the magnet, etc., it is possible to transfer fragile samples, such as, e.g., analytical samples and glass parts, by the same mechanism. As a result, it is possible to suppress an increase in size of a device and transfer a sample container without using an exclusively designed sample container and a mechanism for fixing a sample container.

In the sample transfer device according to the above one aspect of the present invention, preferably, the sample transfer device further includes: a vertical direction moving mechanism configured to independently move the sample container holding unit and the sample suction and discharge unit in a vertical direction.

By configuring as described above, the movement of the sample container holding unit and the movement of the sample suction and discharge unit in the vertical direction can be performed independently. Therefore, when holding the sample container by the sample container holding unit, it is possible to suppress that the sample suction and discharge unit comes into contact with other sample containers. Further, when the sample suction and discharge unit suctions and discharges the sample, it is possible to suppress that the sample container holding unit comes into contact with other sample containers or a device for discharging the sample. As a result, as compared with the configuration of integrally moving the sample container holding unit and the sample suction and discharge unit in the vertical direction, since it becomes unnecessary to consider that the sample container holding unit and the sample suction and discharge unit interfere with each other, it is possible to suppress the device configuration from becoming complicated.

In the sample transfer device according to the above one aspect of the present invention, preferably, the sample container holding unit and the sample suction and discharge unit are arranged at different positions in the horizontal direction.

By configuring as described above, since the sample container holding unit and the sample suction and discharge unit are no longer arranged coaxially, it becomes unnecessary to provide a movable region for the sample suction and discharge unit inside the sample container holding unit, which in turn can suppress the structure of the sample container holding unit from becoming complicated.

In the sample transfer device according to the above one aspect of the present invention, preferably, the sample suction and discharge unit is configured to suction the sample to be analyzed by a chromatography apparatus and discharge the sample at a predetermined position of the chromatography apparatus.

By configuring as described above, even in the case of performing an analysis by a chromatography apparatus, it is possible to suppress the enlargement of the device, and the transfer of the sample container can be performed without using an exclusively designed sample container and a mechanism for fixing a sample container (lid portion).

In the sample transfer device according to the above one aspect of the present invention, preferably, the sample suction and discharge unit is provided with a needle for suctioning and discharging the sample, the sample container holding unit is provided with a container contact member which comes into contact with a lid portion of the sample container, and the container contact member is configured to come into contact with the lid portion without coming into contact with a needle penetration portion provided in the lid portion into which the needle is pierced when the sample suction and discharge unit suctions the sample.

By configuring as described above, since it becomes possible to suppress that the container contact member comes into contact with the needle penetration portion, it is possible to suppress the entry of foreign substances into the sample container when acquiring the sample.

In this case, preferably, the container contact member is configured to come into contact with the lid portion on an outer peripheral side outer than the needle penetration portion provided on an inner peripheral side of the lid portion.

By configuring as described above, since the container contact member comes into contact with the outer peripheral side lid portion outer than the needle penetration portion, it is possible to further suppress the entry of foreign substances into the sample container when acquiring the sample.

In the configuration in which the container contact member comes into contact with the outer peripheral side of the lid portion outer than the needle penetration portion provided on the inner peripheral side of the lid portion, preferably, the container contact member has a cylindrical shape, an outer periphery of the container contact member has a diameter smaller than a diameter of the lid portion, and an inner periphery of the container contact member has a diameter larger than a diameter of the needle penetration portion.

By configuring as described above, for example, even in cases where the needle penetration portion is provided so as to project from the upper surface portion of the lid portion, since the shape of the container contact member is cylindrical and the inner periphery of the container contact member has a diameter larger than the diameter of the needle penetration portion, it is possible to suppress that the container contact member comes into contact with the needle penetration portion. As a result, even in cases where the needle penetration portion is provided so as to protrude from the upper surface portion of the lid portion, the sample container can be transferred while suppressing that the container contact member comes into contact with the needle penetration portion without exchanging the container contact member.

In the sample transfer device according to the above one aspect of the present invention, preferably, the sample transfer device further includes: a holding determination unit configured to determine whether the sample container holding unit is holding the sample container based on magnitude of the negative pressure supplied to the sample container holding unit.

By configuring as described above, it is possible to grasp whether the sample container holding unit is holding the sample container based on the magnitude of the negative pressure supplied to the sample container holding unit. As a result, for example, as compared with the case in which the sample container is held using a magnet or the like, it is possible to more accurately grasp whether the sample container could be held. Further, based on the number of times that the sample container holding unit failed to hold the sample container, it is possible to grasp whether the size of the sample container holding unit or the like with respect to the sample container is appropriate.

In this case, preferably, the sample transfer device further includes: a holding unit position acquisition unit configured to acquire a position of the sample container holding unit in the horizontal direction, wherein the holding determination unit is configured to be able to determine whether the sample container has been moved to a predetermined position based on a position of the sample container holding unit and the magnitude of the negative pressure supplied to the sample container holding unit.

By configuring as described above, it is possible to grasp whether the sample container has moved to a predetermined place. Therefore, for example, in cases where the sample container has not been transferred to the predetermined position, for example, when the sample container has been dropped from the sample container holding unit during the transferring, it is possible to stop suctioning the sample by the sample suction and discharge unit. As a result, it is possible to suppress that the sample suction and discharge unit cannot suction the sample since the sample container is not arranged at the predetermined position, it is possible to suppress performing the analysis without discharging the sample to the analysis device or the like.

### BRIEF DESCRIPTION OF THE DRAWINGS

FIG. 1 is a block diagram showing an entire configuration of a sample transfer device according to a first embodiment.

FIG. 2 is a schematic diagram of the sample transfer device according to the first embodiment as viewed from above.

FIG. 3 is a schematic diagram of the sample transfer device according to the first embodiment as viewed from the side.

FIG. 4 is a diagram of a mechanism for moving a sample suction and discharge unit according to the first embodiment in the vertical direction.

FIG. 5 is a schematic diagram of a sample container to be transferred by the sample transfer device according to the first embodiment.

FIG. 6 is a cross-sectional view taken along the line 500-500 in FIG. 5.

FIG. 7 is a schematic diagram of a lid portion of the sample container to be transferred by the sample transfer device according to the first embodiment as viewed from above.

FIG. 8 is a schematic diagram of the state in which the container contact member and the sample container according to the first embodiment are in contact with each other.

FIG. 9A is a schematic diagram for explaining a size of the container contact member according to the first embodiment.

FIG. 9B is a schematic diagram for explaining a size of a needle penetration portion according to the first embodiment.

FIG. 10A is a schematic diagram for explaining the movement of the sample container holding unit according to the first embodiment in the horizontal direction.

FIG. 10B is a schematic diagram for explaining the movement of the sample container holding unit according to the first embodiment in the vertical direction.

FIG. 10C is a schematic diagram for explaining the processing when the sample container holding unit according to the first embodiment supplies a negative pressure.

FIG. 10D is a schematic diagram for explaining the processing in which the sample container holding unit according to the first embodiment holds the sample container.

FIG. 10E is a schematic diagram for explaining the movement of the the sample container holding unit in the horizontal direction after the sample container holding unit according to the first embodiment holds the sample container.

FIG. 10F is a schematic diagram for explaining the movement of the the sample container holding unit in the vertical direction after the sample container holding unit according to the first embodiment holds the sample container.

FIG. 10G is a schematic diagram for explaining the processing in which the sample container holding unit according to the first embodiment stops the supply of the negative pressure.

FIG. 10H is a schematic diagram for explaining the processing in which the sample container holding unit according to the first embodiment arranges the sample container.

FIG. 11 is a schematic diagram for explaining the determination criteria when determining whether the holding determination unit according to the first embodiment is holding the sample container.

FIG. 12 is a flowchart for explaining the processing of determining whether the holding determination unit according to the first embodiment could hold the sample container.

FIG. 13 is a flowchart for explaining the processing in which the control unit according to the first embodiment determines the state of the container contact member.

FIG. 14 is a block diagram showing an entire configuration of a sample transfer device according to a second embodiment.

FIG. 15 is a flowchart for explaining the processing in which the holding determination unit according to the second embodiment determines whether the sample container could be transferred to a predetermined position.

FIG. 16 is a side view showing the arrangement of the sample container holding unit and the sample suction and discharge unit according to a first modification.

FIG. 17A is a schematic diagram showing the positional relationship between the container contact member and the needle according to the first modification.

FIG. 17B is a schematic diagram for explaining the structure of the container contact member according to the first modification.

FIG. 18 is a schematic diagram of a negative pressure supply unit according to a second modification.

### DESCRIPTION OF PREFERRED EMBODIMENTS

Hereinafter, embodiments embodying the present invention will be described with reference to the drawings.

### First Embodiment

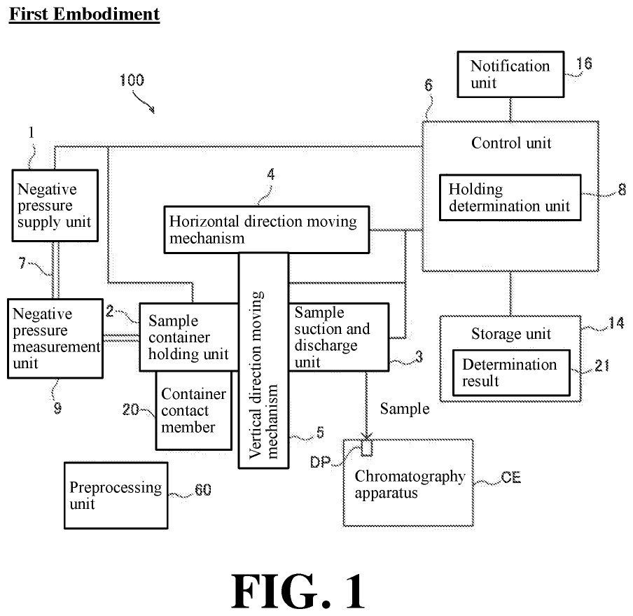

With reference to FIG. 1 to FIG. 4, the configuration of a sample transfer device 100 according to a first embodiment of the present embodiment will be described.

### Configuration of Sample Transfer Device

First, with reference to FIG. 1, the configuration of the sample transfer device 100 according to the first embodiment will be described.

As shown in FIG. 1, the sample transfer device 100 is provided with a negative pressure supply unit 1, a sample container holding unit 2, a sample suction and discharge unit 3, a horizontal direction moving mechanism 4, a vertical direction moving mechanism 5, a control unit 6, and a negative pressure measurement unit 9, a storage unit 14, a notification unit 16, and a preprocessing unit 60.

The negative pressure supply unit 1 is configured to supply negative pressure to the sample container holding unit 2 under the control of the control unit 6. Specifically, the negative pressure supply unit 1 is configured to supply negative pressure to the sample container holding unit 2 by suctioning air. The negative pressure supply unit 1 includes, for example, a vacuum pump.

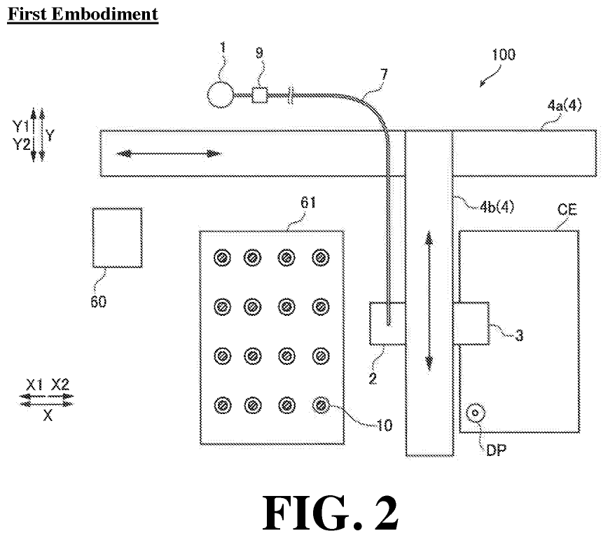

The sample container holding unit 2 is connected to the negative pressure supply unit 1 by the tubular member 7 (see FIG. 2), and is configured to be supplied with negative pressure from the negative pressure supply unit 1. The sample container holding unit 2 is configured to hold the sample container 10 (see FIG. 2) by the supplied negative pressure. Specifically, the sample container holding unit 2 is configured to hold the sample container 10 by suctioning the sample container 10 by the negative pressure supplied in a state of being in contact with the sample container 10. The details of the configuration in which the sample container holding unit 2 holds the sample container 10 will be described later.

The sample suction and discharge unit 3 is configured to suction the sample from the sample container 10 and discharge the sample at a predetermined position. The sample suction and discharge unit 3 is provided with a needle 30 for suctioning and discharging the sample. The needle 30 is, for example, a suction tube having a hollow structure. The sample suction and discharge unit 3 includes, for example, a syringe connected to the needle 30.

The horizontal direction moving mechanism 4 is configured to integrally move the sample container holding unit 2 together with the sample suction and discharge unit 3 in the horizontal direction under the control of the control unit 6. The details of the configuration of the horizontal direction moving mechanism 4 will be described later.

The vertical direction moving mechanism 5 is configured to independently move the sample container holding unit 2 and the sample suction and discharge unit 3 in the vertical direction under the control of the control unit 6. The details of the configuration of the vertical direction moving mechanism 5 will be described later.

The control unit 6 is configured to supply negative pressure to the sample container holding unit 2 by controlling the negative pressure supply unit 1. The control unit 6 is configured to integrally move the sample container holding unit 2 and the sample suction and discharge unit 3 in the horizontal direction by controlling the horizontal direction moving mechanism 4. The control unit 6 is configured to independently move the sample container holding unit 2 and the sample suction and discharge unit 3 in the vertical direction by controlling the vertical direction moving mechanism 5. The control unit 6 is configured to perform control to determine the state of the container contact member 20 described later. The control unit 6 includes, for example, a CPU (Central Processing Unit), a ROM (Read Only Memory), a RAM (Random Access Memory), and the like. The details of the control in which the control unit 6 determines the state of the container contact member 20 will be described later.

The control unit 6 includes a holding determination unit 8. The holding determination unit 8 is configured to determine whether the sample container holding unit 2 is holding the sample container 10. In the first embodiment, the control unit 6 is configured to function as a holding determination unit 8 by executing a program stored in the storage unit 14. The detailed configuration of determining whether the sample container holding unit 2 is holding the sample container 10 by the holding determination unit 8 will be described later.

The negative pressure measurement unit 9 is provided to a tubular member 7 connecting the negative pressure supply unit 1 and the sample container holding unit 2, and is configured to measure the negative pressure supplied to the sample container holding unit 2. The negative pressure supply unit 1 includes, for example, a pressure sensor.

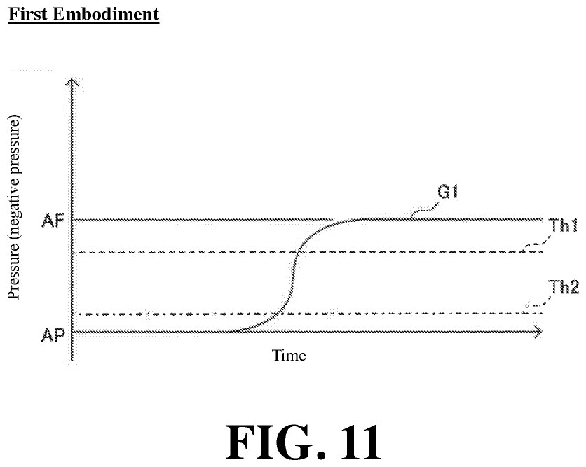

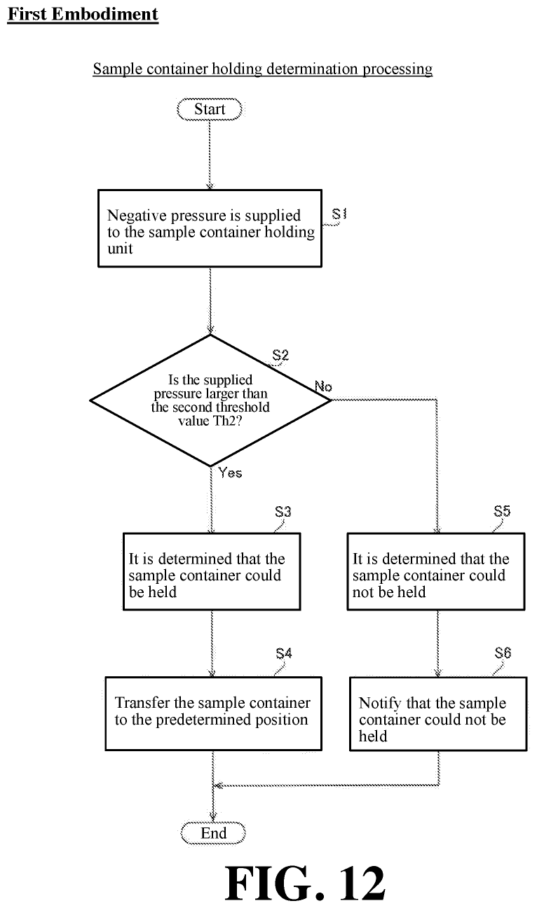

The storage unit 14 is storing a program that the control unit 6 executes. The storage unit 14 is storing a first threshold value Th1 (see FIG. 11) and a second threshold value Th2 (see FIG. 11) used when the control unit 6 performs control to determine the state of the container contact member 20. The second threshold value Th2 is used also to determine whether the holding determination unit 8 is holding the sample container 10. Further, the storage unit 14 is configured to store the determination result 21 of the control unit 6. The storage unit 14 includes, for example, a non-volatile memory or a hard disk drive (HDD).

The notification unit 16 is configured to notify the determination result 21 of the holding determination unit 8. The notification unit 16 is configured to notify the negative pressure state of the container contact member 20 described later. The notification unit 16 may have any configuration as long as it can notify the determination result 21 of the holding determination unit 8 and the negative pressure state of the container contact member 20. In the first embodiment, the notification unit 16 includes, for example, a light source which emits different colors depending on the negative pressure state. The detailed configuration in which the notification unit 16 notifies the determination result 21 of the holding determination unit 8 and the negative pressure state of the container contact member 20 will be described later.

The preprocessing unit 60 is configured to perform preprocessing of a sample to be analyzed by the chromatography apparatus CE. The preprocessing unit 60 is configured to perform, for example, heating processing on a sample as preprocessing. The preprocessing unit 60 includes, for example, a sample heating device. It may be configured such that the preprocessing unit 60 includes a sample stirring device and performs stirring processing of the sample as preprocessing.

### Horizontal Direction Moving Mechanism

Next, with reference to FIG. 2, the configuration of the horizontal direction moving mechanism 4 in the first embodiment will be described.

As shown in FIG. 2, the horizontal direction moving mechanism 4 includes a first direction moving mechanism 4a and a second direction moving mechanism 4b. Note that in the first embodiment, the first direction is denoted as an X-direction. Of the X-directions, one of the X-directions is denoted as an X1-direction and the other thereof is denoted as an X2-direction. Also note that in the example shown in FIG. 2, in the second direction moving mechanism 4b, the direction in which the sample container holding unit 2 is provided is denoted as an X1-direction. Further, in the second direction moving mechanism 4b, the direction on the side where the sample suction and discharge unit 3 is provided is denoted as an X2-direction. Also, in the first embodiment, the second direction is denoted as a Y-direction. Of the Y-directions, one of the Y-directions is denoted as a Y1-direction and the other thereof is denoted as a Y2-direction. In the example shown in FIG. 2, the direction on the first direction moving mechanism 4a side in the second direction moving mechanism 4b is denoted as a Y1-direction, and the opposite direction is denoted as a Y2-direction. The X-direction and the Y-direction are directions orthogonal to each other in the horizontal plane.

The first direction moving mechanism 4a is configured to move the second direction moving mechanism 4b in the X-direction. Specifically, the first direction moving mechanism 4a is holding one end side (Y1 side) of the second direction moving mechanism 4b. The first direction moving mechanism 4a is configured to move the second direction moving mechanism 4b in the X-direction by moving the second direction moving mechanism 4b on the first direction moving mechanism 4a. The first direction moving mechanism 4a includes, for example, a linear motion mechanism, such as, e.g., a ball screw mechanism and a rack and pinion mechanism.

The second direction moving mechanism 4b is configured to move the sample container holding unit 2 and the sample suction and discharge unit 3 in the Y-direction. Specifically, in the second direction moving mechanism 4b, the sample container holding unit 2 and the sample suction and discharge unit 3 are provided, and the second direction moving mechanism 4b is configured to move the sample container holding unit 2 and the sample suction and discharge unit 3 in the Y-direction. The second direction moving mechanism 4b includes, for example, a linear motion mechanism, such as, e.g., a ball screw mechanism and a rack and pinion mechanism.

In the example shown in FIG. 2, the sample container holding unit 2 is provided on the side (X1-direction side) where the first sample container placement portion 61 of the second direction moving mechanism 4b is arranged. Further, the sample suction and discharge unit 3 is provided on the side (X2-direction side) where the chromatography apparatus CE of the second direction moving mechanism 4b is arranged. That is, in the first embodiment, the sample container holding unit 2 and the sample suction and discharge unit 3 are arranged at different positions in the horizontal direction.

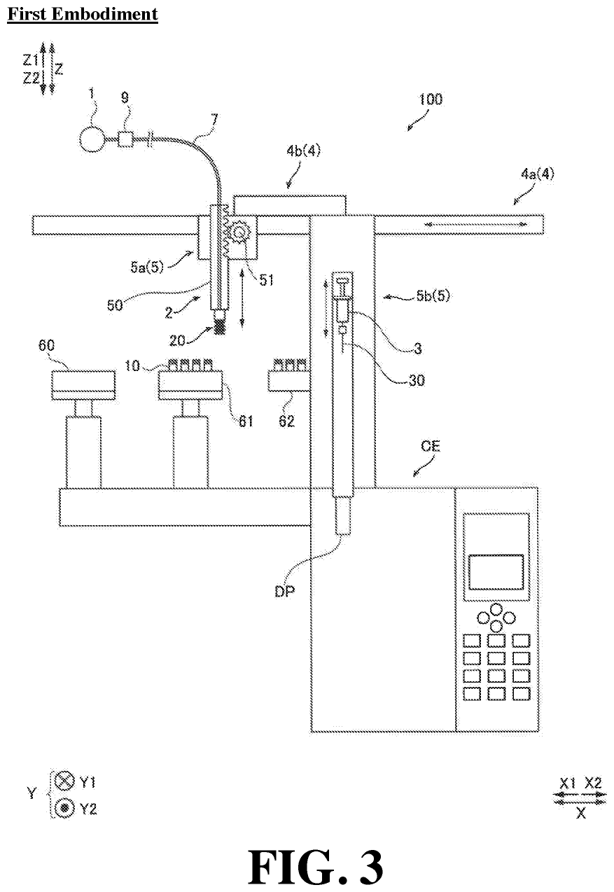

In the example shown in FIG. 2, the sample container holding unit 2 and the sample suction and discharge unit 3 are provided to the first direction moving mechanism 4a via the second direction moving mechanism 4b. Therefore, the sample container holding unit 2 and the sample suction and discharge unit 3 are integrally moved in the Y-direction by the second direction moving mechanism 4b, and are integrally moved in the X-direction by the first direction moving mechanism 4a. Thus, in the first embodiment, the horizontal direction moving mechanism 4 is configured to be able to move the sample container holding unit 2 and the sample suction and discharge unit 3 in the XY plane. The horizontal direction moving mechanism 4 is configured to be able to move the sample container holding unit 2 at least from the position of the second sample container placement portion 62 (see FIG. 3) to the position of the preprocessing unit 60. The horizontal direction moving mechanism 4 is configured to be able to move the sample suction and discharge unit 3 at least from the position of the first sample container placement portion 61 to the position of the sample inlet port DP of the chromatography apparatus CE. Note that the sample inlet port DP of the chromatography apparatus CE is an example of the “predetermined position of a chromatography apparatus” recited in claims.

### Vertical Direction Moving Mechanism

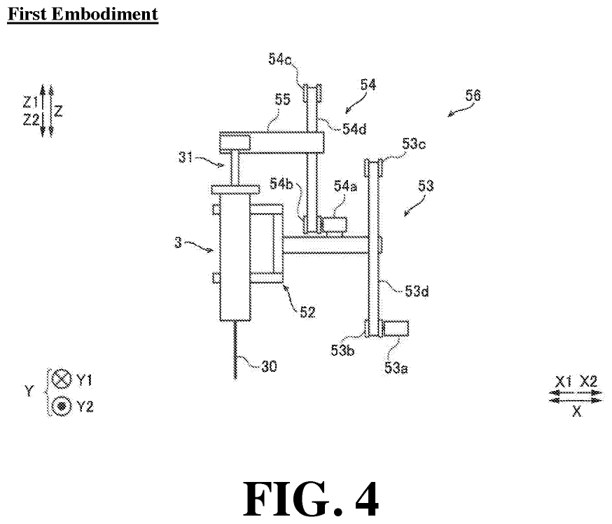

Next, with reference to FIG. 3 and FIG. 4, the configuration of the vertical direction moving mechanism 5 according to the first embodiment will be described. Note that in the first embodiment, the direction along which the sample container holding unit 2 and the sample suction and discharge unit 3 are moved by the vertical direction moving mechanism 5 is denoted as a Z-direction. Of the Z-directions, the direction on the side of the horizontal direction moving mechanism 4 in the vertical direction moving mechanism 5 is denoted as a Z1-direction. Further, a direction opposite to the Z1-direction is denoted as a Z2-direction.

As shown in FIG. 3, the vertical direction moving mechanism 5 includes a first vertical direction moving mechanism 5a and a second vertical direction moving mechanism 5b. The first vertical direction moving mechanism 5a is configured to move the sample container holding unit 2 in the vertical direction. The second vertical direction moving mechanism 5b is configured to move the sample suction and discharge unit 3 in the vertical direction. Therefore, the vertical direction moving mechanism 5 is configured to be able to independently move the sample container holding unit 2 and the sample suction and discharge unit 3 in the vertical direction.

The first vertical direction moving mechanism 5a includes a sample container holding unit installation unit 50 and a drive unit 51. As an example, in FIG. 3, the sample container holding unit 2 is provided on one end side (Z2-direction side) of the sample container holding unit installation unit 50, and a rack (groove) is provided on the other end side (Z1-direction side). The first vertical direction moving mechanism 5a is configured to move the sample container holding unit installation unit 50 in the vertical direction by rotating the pinion engaged with the rack by the drive unit 51. The first vertical direction moving mechanism 5a is a so-called rack and pinion mechanism.

FIG. 4 is a schematic diagram of the second vertical direction moving mechanism 5b as viewed in the Y-direction. As shown in FIG. 4, the second vertical direction moving mechanism 5b includes a support portion 52, a support portion moving mechanism 53, and a plunger moving mechanism 54.

The support portion 52 is provided to the support portion moving mechanism 53, and is configured to hold the sample suction and discharge unit 3.

The support portion moving mechanism 53 is configured to move the support portion 52 in the vertical direction (Z-direction). The support portion moving mechanism 53 includes a first motor 53a, a first pulley 53b, a second pulley 53c, and a first belt 53d put on the first pulley 53b and the second pulley 53c. The first belt 53d is provided with a support portion 52, and the support portion 52 is moved in the vertical direction when the first belt 53d is moved by the rotation of the first motor 53a. That is, the support portion moving mechanism 53 is configured to move the sample suction and discharge unit 3 in the vertical direction by moving the support portion 52 in the vertical direction by the rotation of the first motor 53a. The support portion moving mechanism 53 is a so-called belt and pulley mechanism.

### Configuration in Which Sample Suction and Discharge Unit Suctions and Discharges Sample

The sample suction and discharge unit 3 is provided with a needle 30 and a plunger 31. The plunger 31 is fitted in the sample suction and discharge unit 3, and is configured to suction and discharge the sample by moving the plunger 31 provided in the sample suction and discharge unit 3 in the up-down direction by the plunger moving mechanism 54. The plunger moving mechanism 54 includes a second motor 54a, a third pulley 54b, a fourth pulley 54c, and a second belt 54d put on the third pulley 54b and the fourth pulley 54c. The second belt 54d is provided with a plunger holding portion 55, and the second belt 54d is moved by the rotation of the second motor 54a to move the plunger 31 in the vertical direction by moving the plunger holding portion 55 in the vertical direction. The plunger moving mechanism 54 is a so-called belt and pulley mechanism.

When the plunger 31 is moved in the upward direction by the plunger moving mechanism 54, the sample is suctioned into the sample suction and discharge unit 3 through the needle 30. Further, when the plunger 31 is moved in the downward direction by the plunger moving mechanism 54 after the sample suction, the sample in the sample suction and discharge unit 3 is discharged through the needle 30.

Further, the plunger moving mechanism 54 is provided to the support portion 52, and moves integrally with the support portion 52. That is, the support portion moving mechanism 53 is configured to control the vertical position of the needle 30, and the plunger moving mechanism 54 is configured to control suction and discharge of the sample.

In the first embodiment, the sample suction and discharge unit 3 is configured to suction the sample to be analyzed by the chromatography apparatus CE from the sample container 10 and discharge the sample to the sample inlet port DP of the chromatography apparatus CE. Specifically, by moving the sample container holding unit 2 in the horizontal direction and in the vertical direction by the horizontal direction moving mechanism 4 and the vertical direction moving mechanism 5, the sample container 10 is moved from the first sample container placement portion 61 to the preprocessing unit 60 to perform sample preprocessing. Also, the sample container 10 after preprocessing is moved to the second sample container placement portion 62 (see FIG. 3) by the horizontal direction moving mechanism 4 and the vertical direction moving mechanism 5. Further, the sample suction and discharge unit 3 is moved by the horizontal direction moving mechanism 4 and the vertical direction moving mechanism 5 to the second sample container placement portion 62 where the sample container 10 is placed, the sample after preprocessing in the sample container 10 is suctioned and discharged to the sample inlet port DP of the chromatography apparatus CE.

### Configuration of Sample Container

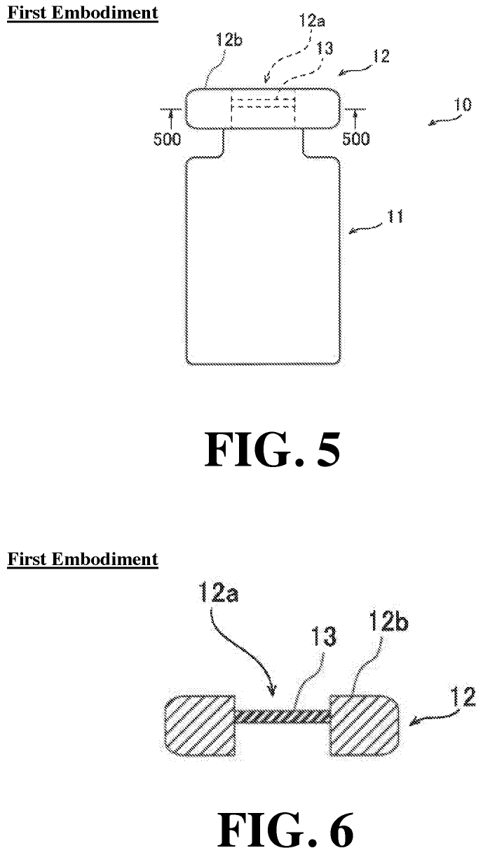

Next, with reference to FIG. 5 to FIG. 7, the structure of the sample container 10 will be described.

As shown in FIG. 5, the sample container 10 is configured by a container portion 11 and a lid portion 12. In the container portion 11, a sample to be analyzed is contained. The container portion 11 has an opening portion at one end side, and has a tubular (cylindrical) shape in which the other end side is closed. The container portion 11 is made of, for example, resin or glass. The lid portion 12 seals the container portion 11 by closing the opening portion of the container portion 11. The sample container 10 is configured to be able to suction the sample therein by the needle 30 without opening the lid portion 12.

Specifically, the lid portion 12 is provided with a needle penetration portion 13 into which the needle 30 is pierced when the sample suction and discharge unit 3 suctions the sample. More specifically, the lid portion 12 is provided with a through-hole 12a, and the needle penetration portion 13 is provided so as to close the through-hole 12a. When the sample contained in the sample container 10 is suctioned, the needle 30 pierces through the needle penetration portion 13 to reach the sample of the container portion 11. The needle penetration portion 13 is made of a material capable of sealing the inside of the sample container 10 even after the sample is suctioned by the sample suction and discharge unit 3. The needle penetration portion 13 is formed of, for example, a flexible material such as rubber.

The needle penetration portion 13 may be provided at any height as long as it is within the through-hole 12a. In the first embodiment, as shown in FIG. 6, the needle penetration portion 13 is provided at a position slightly recessed from the upper surface portion 12b of the lid portion 12 in the through-hole 12a.

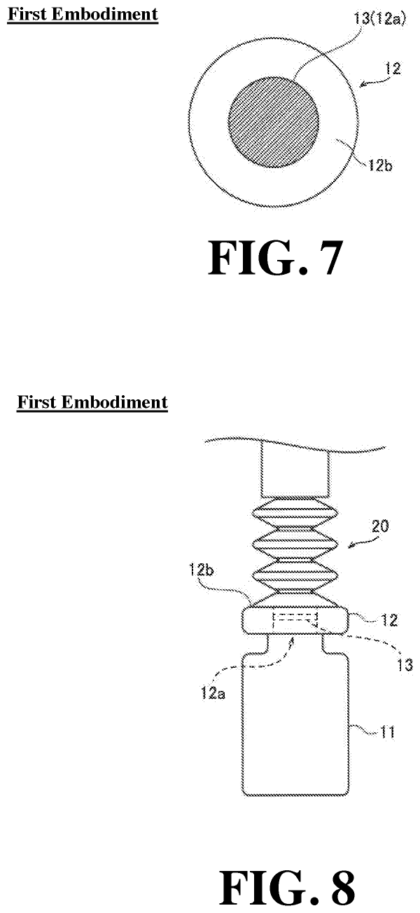

The needle penetration portion 13 may be provided at any position of the lid portion 12. In the first embodiment, as shown in FIG. 7, the needle penetration portion 13 is provided, for example, on the inner peripheral side of the lid portion 12.

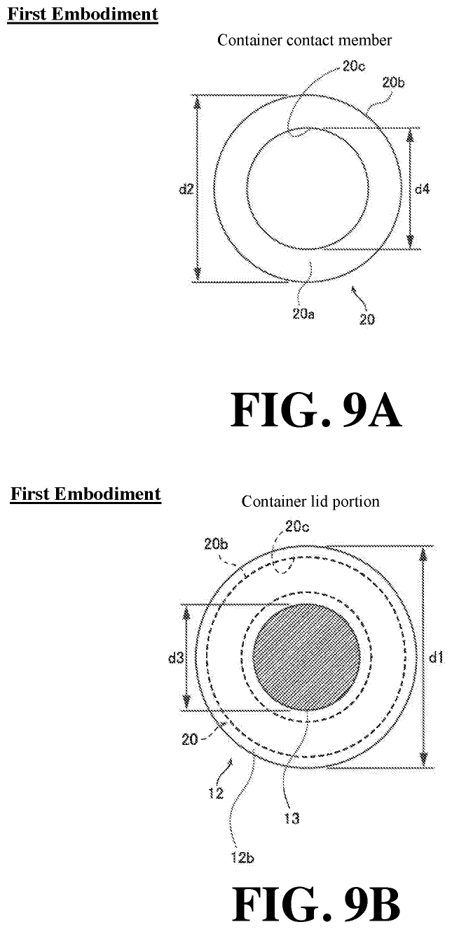

As shown in FIG. 8, the sample container holding unit 2 is provided with a container contact member 20 which comes into contact with the lid portion 12 of the sample container 10. The container contact member 20 is exchangeably attached to the sample container holding unit 2. The container contact member 20 is configured to suction the sample container 10 by the negative pressure supplied to a substantially sealed region inside the container contact member 20 formed by closely contacting the upper surface portion 12b of the lid portion 12 and the lower surface (contact surface 20a (see FIG. 9A)) of the container contact member 20. Further, the container contact member 20 has a cylindrical shape. The container contact member 20 includes, for example, a vacuum pad.

In the first embodiment, when holding the sample container 10 by the sample container holding unit 2, the container contact member 20 is configured to be brought into contact with the upper surface portion 12b of the lid portion 12. Specifically, the container contact member 20 is configured to come into contact with the lid portion 12 without coming into contact with the needle penetration portion 13 of the lid portion 12 into which the needle 30 is pierced when the sample suction and discharge unit 3 suctions the sample.

FIG. 9A is a schematic diagram of the contact surface 20a of the container contact member 20. FIG. 9B is a schematic diagram of the lid portion 12 as viewed from above.

In the first embodiment, the container contact member 20 is configured to come into contact with the outer peripheral side of the lid portion 12 outer than the needle penetration portion 13 provided on the inner peripheral side of the lid portion 12. Specifically, as shown in FIG. 9A and FIG. 9B, the outer periphery 20b of the container contact member 20 has a diameter d2 smaller than the diameter d1 of the lid portion 12. The inner periphery 20c of the container contact member 20 has a diameter d4 larger than the diameter d3 of the needle penetration portion 13. Therefore, the container contact member 20 comes into contact with the lid portion 12 without coming into contact with the needle penetration portion 13 on the outer peripheral side outer than the needle penetration portion 13 provided on the inner peripheral side of the lid portion 12. The area of the contact surface 20a of the container contact member 20 is smaller than the area of the upper surface portion 12b of the lid portion 12 except for the needle penetration portion 13.

### Transfer of Sample Container

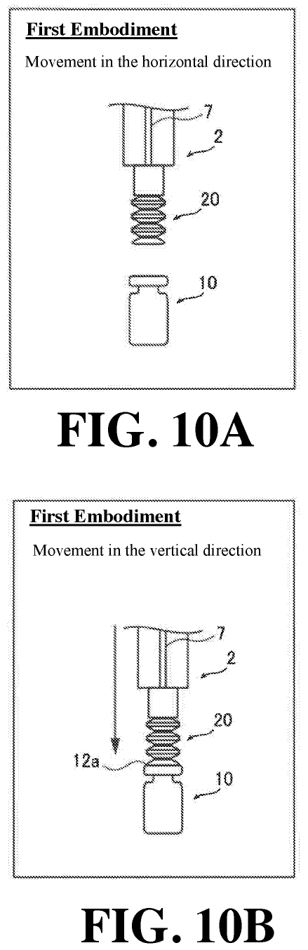

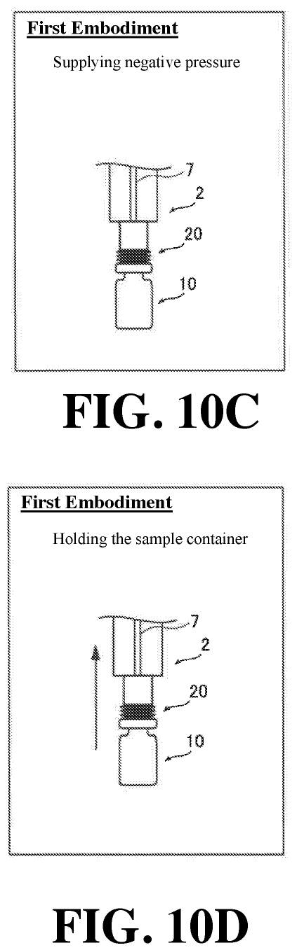

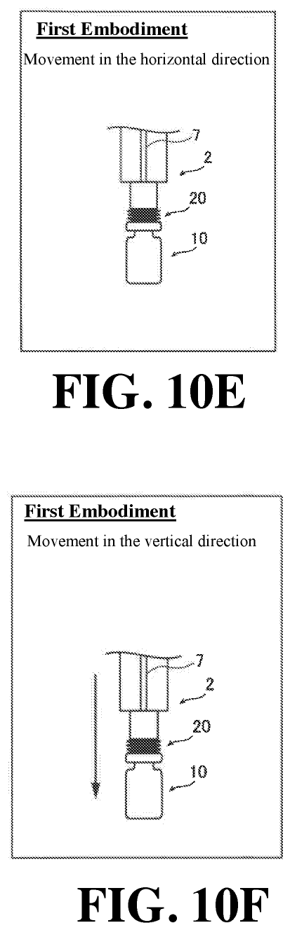

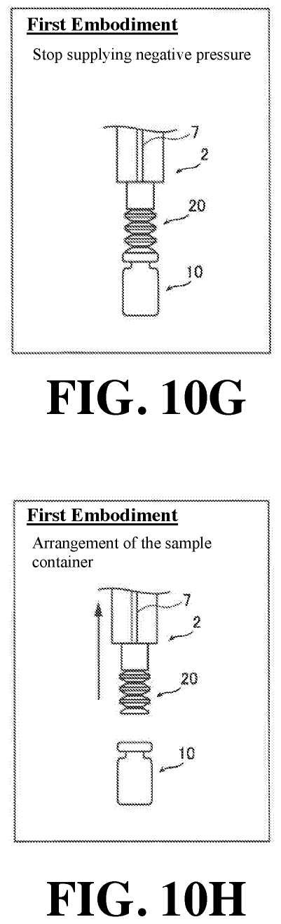

FIG. 10 is a schematic diagram showing the flow of processing when the sample transfer device 100 transfers the sample container 10.

As shown in FIG. 10A, the control unit 6 controls the horizontal direction moving mechanism 4 to move the sample container holding unit 2 to the position of the first sample container placement portion 61 where the sample container 10 is arranged. Thereafter, as shown in FIG. 10B, the control unit 6 controls the vertical direction moving mechanism 5 to move the sample container holding unit 2 in the vertical direction to a height at which the container contact member 20 comes into contact with the upper surface portion 12b of the lid portion 12 of the sample container 10. As shown in FIG. 10C, in a state where the container contact member 20 and the upper surface portion 12b of the lid portion 12 are in contact with each other, the control unit 6 controls the negative pressure supply unit 1 to supply negative pressure to the sample container holding unit 2. By supplying the negative pressure, the sample container holding unit 2 holds the sample container 10 as shown in FIG. 10D.

After the sample container holding unit 2 holds the sample container 10, as shown in FIG. 10E, the control unit 6 controls the horizontal direction moving mechanism 4 to move the sample container holding unit 2 to the position of the preprocessing unit 60. As shown in FIG. 10F, after moving the sample container 10 to the position of the preprocessing unit 60, the control unit 6 controls the vertical direction moving mechanism 5 to move the sample container 10 to a height at which the preprocessing unit 60 is arranged. As shown in FIG. 10G, the control unit 6 controls the negative pressure supply unit 1 to stop the supply of the negative pressure from the negative pressure supply unit 1 to the sample container holding unit 2. As shown in FIG. 10H, the control unit 6 controls the vertical direction moving mechanism 5 to move the sample container holding unit 2 in the vertical direction, and complete the movement of the sample container 10. The configuration for moving the sample container 10 from the position of the preprocessing unit 60 to the position of the second sample container placement portion 62 is the same as the configuration for moving the sample container 10 from the position of the first sample container placement portion 61 to the position of the preprocessing unit 60.

### Determination by Holding Determination Unit

FIG. 11 is a graph G1 showing the change in the negative pressure supplied to the sample container holding unit 2 measured by the negative pressure measurement unit 9. The horizontal axis of the graph G1 denotes time, and the vertical axis denotes pressure. In the following description, the negative pressure denotes the negative (minus) pressure difference from atmospheric pressure AP, and the magnitude of the negative pressure denotes the difference value (absolute value) between the measured pressure value of the negative pressure measurement unit 9 and atmospheric pressure AP.

When the negative pressure is not supplied by the negative pressure supply unit 1, the pressure related to the sample container holding unit 2 becomes the same value as the atmospheric pressure AP. When holding the sample container 10 by the sample container holding unit 2, the negative pressure is supplied by the negative pressure supply unit 1, so the negative pressure (pressure) supplied to the sample container holding unit 2 increases. Note that in the first embodiment, a predetermined negative pressure capable of holding the sample container 10 by the sample container holding unit 2 is supplied from the negative pressure supply unit 1, so that when the sample container holding unit 2 holds the sample container 10, the value in the graph G1 is approximately constant at a predetermined pressure value AF.

In the graph G1, the first threshold value Th1 is a value (pressure value) used to determine whether the sample container holding unit 2 is being able to hold the sample container 10 with a predetermined holding power. Further, the second threshold value Th2 is a value (pressure value) used to determine whether the sample container holding unit 2 is being able to hold the sample container 10.

The first threshold value Th1 and the second threshold value Th2 are determined based on the size of the inner diameter of the tubular member 7, the length of the tubular member 7 connecting the negative pressure supply unit 1 and the sample container holding unit 2, and the shape of the container contact member 20. Here, since the size of the inner diameter of the tubular member 7 and the length of the tubular member 7 connecting the negative pressure supply unit 1 and the sample container holding unit 2 are known values in design, so the first threshold value Th1 and the second threshold value Th2 are determined based on the shape of the container contact member 20 to be used.

In the first embodiment, the holding determination unit 8 is configured to determine whether the sample container holding unit 2 is holding the sample container 10 based on the magnitude of the negative pressure supplied to the sample container holding unit 2.

In particular, the holding determination unit 8 determines whether the sample container holding unit 2 is holding the sample container 10 depending on whether the magnitude of the negative pressure supplied to the sample container holding unit 2 is greater than or equal to the second threshold value Th2. That is, the holding determination unit 8 determines that the sample container holding unit 2 is holding the sample container 10 when the magnitude of the negative pressure supplied to the sample container holding unit 2 is equal to or greater than the second threshold value Th2. Further, the holding determination unit 8 determines that the sample container holding unit 2 could not hold the sample container 10 when the magnitude of the negative pressure supplied to the sample container holding unit 2 is smaller than the second threshold value Th2. Note that since the negative pressure supplied from the negative pressure supply unit 1 is changed according to the shape of the container contact member 20, the value of the second threshold value Th2 used by the holding determination unit 8 for determination changes according to the shape of the container contact member 20.

The notification unit 16 is configured to notify the determination result 21 of the holding determination unit 8. In the first embodiment, the notification unit 16 is configured to emit lights different in color according to, for example, the determination result 21 of the holding determination unit 8.

In the first embodiment, the notification unit 16 is configured to emit blue light when the sample container holding unit 2 is being able to hold the sample container 10. Further, the notification unit 16 is configured to emit red light when the sample container holding unit 2 cannot hold the sample container 10.

Next, with reference to FIG. 12, in the sample transfer device 100 according to the first embodiment, the flow of a method of determining whether the sample container holding unit 2 is holding the sample container 10 will be described.

In Step S1, the negative pressure supply unit 1 supplies negative pressure to the sample container holding unit 2 under the control of the control unit 6. Thereafter, in Step S2, the holding determination unit 8 determines whether the negative pressure supplied to the sample container holding unit 2 is a value larger than the second threshold value Th2. When the negative pressure supplied to the sample container holding unit 2 is larger than the second threshold value Th2, the processing proceeds to Step S3. When the negative pressure supplied to the sample container holding unit 2 does not have a value larger than the second threshold value Th2, the processing proceeds to Step S5.

In Step S3, the holding determination unit 8 determines that the sample container holding unit 2 could hold the sample container 10. Thereafter, the processing proceeds to Step S4.

In Step S4, the control unit 6 controls the vertical direction moving mechanism 5 and the vertical direction moving mechanism 5 to transfer the sample container 10 to a predetermined position, and ends the processing. In Step S4, the control unit 6 may control the notification unit 16 to notify that the sample container holding unit 2 could hold the sample container 10.

In Step S5, the holding determination unit 8 determines that the sample container holding unit 2 could not hold the sample container 10. Thereafter, in Step S6, the control unit 6 controls the notification unit 16 to notify that the sample container holding unit 2 could not hold the sample container 10. Further, the control unit 6 controls the horizontal direction moving mechanism 4 and the vertical direction moving mechanism 5, stops the transfer of the sample container 10, and ends the processing.

### Determination of Negative Pressure State

Next, with reference to FIG. 11, the configuration for performing the negative pressure state determination processing by the control unit 6 will be described.

The control unit 6 is configured to perform control to determine the state of the container contact member 20 based on the magnitude of the negative pressure supplied to the container contact member 20. Specifically, the control unit 6 is configured to perform control to distinguishably determine whether the container contact member 20 has deteriorated based on the magnitude of the negative pressure, or whether the shape of the container contact member 20 is mismatched with respect to the shape of the sample container 10. More specifically, the control unit 6 is configured to perform control to distinguishably determine whether the container contact member 20 has deteriorated based on the detection result of the time series negative pressure, or whether the shape of container contact member 20 is mismatched with respect to the lid portion 12 of sample container 10.

When the transfer operation is repeated, the container contact member 20 deteriorates, and the degree of sealing between the upper surface portion 12b of the lid portion 12 and the container contact member 20 is reduced. Therefore, the control unit 6 is configured to perform control to determine that the container contact member 20 has deteriorated based on the magnitude of the negative pressure supplied to the container contact member 20, the first threshold value Th1, and the second threshold value Th2 smaller than the first threshold value Th1 when the negative pressure has changed in time series from the first negative pressure state in which the negative pressure is greater than the first threshold value Th1 to a third negative pressure state in which the negative pressure is equal to or smaller than the second threshold value Th2 via a second negative pressure state in which the negative pressure is equal to or smaller than the first threshold value Th1 and greater than the second threshold value Th2. Note that since the negative pressure supplied from the negative pressure supply unit 1 is changed according to the shape of the container contact member 20, the value of the first threshold value Th1 and the value of the second threshold value Th2 used by the control unit 6 for determination change according to the shape of the container contact member 20.

Further, the control unit 6 is configured to perform control to determine that the shape of the container contact member 20 is mismatched with respect to the lid portion 12 of the sample container 10 based on the magnitude of the negative pressure supplied to the container contact member 20, the first threshold value Th1, and the second threshold value Th2 smaller than the first threshold value Th1 when the negative pressure has not become the first negative pressure state where the negative pressure is larger than the first threshold value Th1 and has become the second negative pressure state where the negative pressure is equal to or smaller than the first threshold value Th1 and larger than the second threshold value Th2 or has become the third negative pressure state where the negative pressure value is equal to or smaller than the second threshold value Th2.

The first negative pressure state is a state in which a predetermined negative pressure is supplied to the container contact member 20 and the sample container holding unit 2 can normally hold the sample container 10. The second negative pressure state is a state in which the container contact member 20 has deteriorated and the sample container holding unit 2 can hold the sample container 10 but the holding power is deteriorated as compared with the normal time (first negative pressure state). Further, the third negative pressure state is a state in which the deterioration has progressed further than the container contact member 20 in the second negative pressure state, and the sample container holding unit 2 cannot hold the sample container 10.

The notification unit 16 is configured to notify the negative pressure state of the container contact member 20. In the first embodiment, the notification unit 16 is configured to emit blue light, for example, when the negative pressure state of the container contact member 20 is in the first negative pressure state. Further, the notification unit 16 is configured to emit yellow light, for example, when the negative pressure state of the container contact member 20 is in the second negative pressure state. Further, the notification unit 16 is configured to emit red light, for example, when the negative pressure state of the container contact member 20 is in the third negative pressure state.

In other words, when the sample container holding unit 2 is normally being able to hold the sample container 10 (in the case of the first negative pressure state), the notification unit 16 notifies that the normal holding is being performed by emitting blue light. Further, when the sample container 10 is being held by the sample container holding unit 2 but its holding power is reduced compared with the normal time (in the case of the second negative pressure state), the notification unit 16 notifies the decrease in the holding power by emitting yellow light. Further, in cases where the the sample container cannot be held by the sample container holding unit 2 or there is a possibility that the sample container 10 has been dropped from the sample container holding unit 2 (in the case of the third negative pressure state), the notification unit 16 notifies that the sample container holding unit 2 cannot hold the sample container 10, or there is a possibility that the sample container 10 has been dropped from the sample container holding unit 2 by emitting red light.

Note that the notification unit 16 may be configured by a means other than a light source that emits lights different in color. For example, the notification unit 16 may be configured to notify the negative pressure state of the container contact member 20 by displaying different messages on a display unit or the like according to the negative pressure state of the container contact member 20.

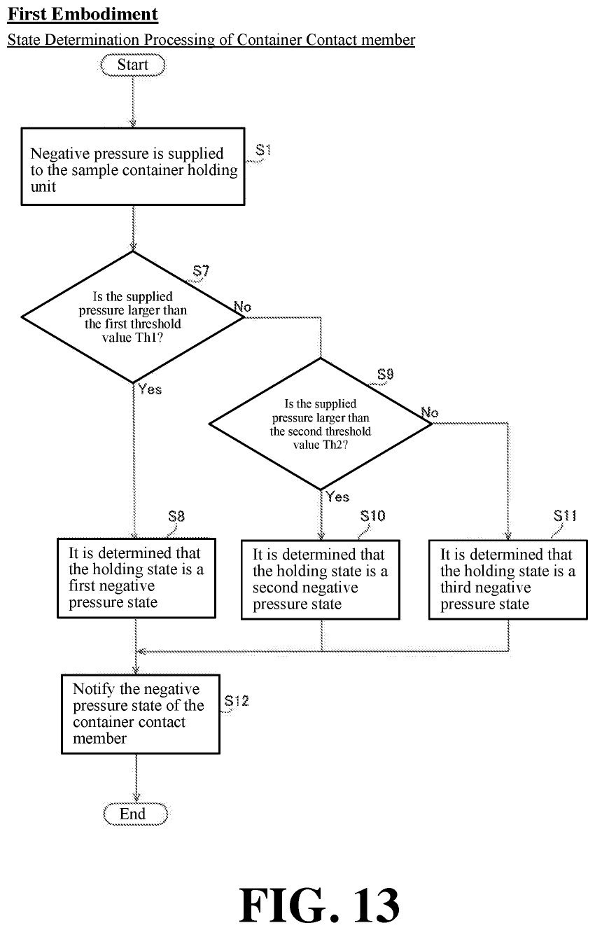

Next, with reference to FIG. 13, in the sample transfer device 100 according to the first embodiment, the flow of a method in which the control unit 6 determines the negative pressure state of the container contact member 20 will be described. As for the same processing as that of the holding determination processing by the holding determination unit 8 shown in FIG. 12, the same reference numerals are given and the description will be omitted.

In Step S1, the control unit 6 causes the negative pressure to be supplied from the negative pressure supply unit 1 to the sample container holding unit 2. Thereafter, in Step S7, the control unit 6 determines whether the negative pressure supplied to the sample container holding unit 2 is larger than the first threshold value Th1. When the negative pressure supplied to the sample container holding unit 2 is larger than the first threshold value Th1, the processing proceeds to Step S8. When the negative pressure supplied to the sample container holding unit 2 is equal to or smaller than the first threshold value Th1, the processing proceeds to Step S9.

In Step S8, the control unit 6 determines that the negative pressure state of the container contact member 20 is in the first negative pressure state. Thereafter, the processing proceeds to Step S12.

In Step S9, the control unit 6 determines whether the negative pressure supplied to the sample container holding unit 2 is larger than the second threshold value Th2. When the negative pressure supplied to the sample container holding unit 2 is larger than the second threshold value Th2, the processing proceeds to Step S10. When the negative pressure supplied to the sample container holding unit 2 is equal to or smaller than the second threshold value Th2, the processing proceeds to Step S12.

In Step S10, the control unit 6 determines that the negative pressure state of the container contact member 20 is in the second negative pressure state. Thereafter, the processing proceeds to Step S12.

In Step S11, the control unit 6 determines that the negative pressure state of the container contact member 20 is in the third negative pressure state. Thereafter, the processing proceeds to Step S12.

In Step S12, the control unit 6 controls the notification unit 16 to notify the negative pressure state of the container contact member 20, and ends the processing.

### Effects of First Embodiment

In the first embodiment, the following effects can be obtained.

In the first embodiment, as described above, the sample transfer device 100 is provided with the negative pressure supply unit 1 configured to supply negative pressure, the sample container holding unit 2 configured to hold the sample container 10 by suctioning the sample container 10 by the negative pressure supplied in a state of being in contact with the sample container 10, the sample suction and discharge unit 3 configured to suction the sample from the sample container 10 and discharge the sample at a predetermined position, and the horizontal direction moving mechanism 4 configured to integrally move the sample container holding unit 2 together with the sample suction and discharge unit 3 in a horizontal direction.

With this, the sample container holding unit 2 and the sample suction and discharge unit 3 can be integrally moved in the horizontal direction by the single horizontal direction moving mechanism 4. As a result, it is possible to suppress an increase in the size of the device, as compared with the case where a moving mechanism for moving the sample container holding unit 2 and a moving mechanism for moving the sample suction and discharge unit 3 in the horizontal direction are separately provided. Further, it becomes possible to hold the sample container 10 by suctioning the sample container 10 by negative pressure, and therefore, unlike the case where the sample container 10 is held by the engagement between the engaging portion and the engaged portion, it is not necessary to replace the sample container 10 having a dedicated structure. In addition, since it becomes possible to release the holding of the sample container 10 by stopping the supply of the negative pressure, for example, as compared with the mechanism for holding the sample container 10 by the engagement between the engaging portion and the engaged portion or by the magnet, etc., when releasing the holding of the sample container 10, there is no need to provide a mechanism for fixing the sample container 10 or the like, so that the device configuration can be simplified. In addition, since the holding force can be adjusted by controlling the supply amount of the negative pressure, it is possible to appropriately change the holding force depending on the type, etc., of the sample container 10. Therefore, for example, as compared with a mechanism for holding the sample container 10 by the engagement between the engaging portion and the engaged portion or by the magnet, etc., it is possible to transfer fragile samples, such as, e.g., analytical samples and glass parts, by the same mechanism. As a result, it is possible to suppress an increase in size of a device and transfer the sample container 10 without using an exclusively designed sample container 10 and a mechanism for fixing the sample container 10.

Further, in the first embodiment, as described above, the vertical direction moving mechanism 5 configured to independently move the sample container holding unit 2 and the sample suction and discharge unit 3 in a vertical direction are further provided. With this, the movement of the sample container holding unit 2 and the movement of the sample suction and discharge unit 3 in the vertical direction can be performed independently. Therefore, when holding the sample container 10 by the sample container holding unit 2, it is possible to suppress that the sample suction and discharge unit 3 comes into contact with other sample containers 10. Further, when the sample suction and discharge unit 3 suctions and discharges the sample, it is possible to suppress that the sample container holding unit 2 comes into contact with other sample containers 10 or a device for discharging the sample. As a result, as compared with the configuration of integrally moving the sample container holding unit 2 and the movement of the sample suction and discharge unit 3 in the vertical direction, since it becomes unnecessary to consider that the sample container holding unit 2 and the sample suction and discharge unit 3 interfere with each other, it is possible to suppress the device configuration from becoming complicated.

Further, in the first embodiment, as described above, the sample container holding unit 2 and the sample suction and discharge unit 3 are arranged at different positions in the horizontal direction. With this, since the sample container holding unit 2 and the sample suction and discharge unit 3 are no longer arranged coaxially, it becomes unnecessary to provide a movable region for the sample suction and discharge unit 3 inside the sample container holding unit 2, which in turn can suppress the structure of the sample container holding unit 2 from becoming complicated.

Further, in the first embodiment, as described above, the sample suction and discharge unit 3 is configured to suction the sample to be analyzed by the chromatography apparatus CE and discharge the sample to the sample inlet port DP of the chromatography apparatus CE. With this, even in the case of performing an analysis by a chromatography apparatus CE, it is possible to suppress the enlargement of the device, and the transfer of the sample container 10 can be performed without using an exclusively designed sample container 10 (lid portion 12) and a mechanism for fixing a sample container 10.

Further, in the first embodiment, as described above, the sample suction and discharge unit 3 is provided with the needle 30 which suctions and discharges a sample, the sample container holding unit 2 is provided with the container contact member 20 that comes into contact with the lid portion 12 of the sample container 10, and the container contact member 20 is configured to come into contact with the lid portion 12 without coming into contact with the needle penetration portion 13 in which the needle 30 is pierced when the sample suction and discharge unit 3 provided in the lid portion 12 suctions the sample. With this, it becomes possible to suppress that the container contact member 20 comes into contact with the needle penetration portion 13, it is possible to suppress the entry of foreign substances into the sample container 10 when acquiring the sample.

Further, in the first embodiment, as described above, the container contact member 20 is configured to come into contact with the outer peripheral side of the lid portion 12 outer than the needle penetration portion 13 provided on the inner peripheral side of the lid portion 12. With this, since the container contact member 20 comes into contact with the outer peripheral side lid portion outer than the needle penetration portion 13, it is possible to further suppress the entry of foreign substances into the sample container 10 when acquiring the sample.

Further, in the first embodiment, as described above, the container contact member 20 has a cylindrical shape, the outer periphery 20b of the container contact member 20 has a diameter d2 smaller than the diameter d1 of the lid portion 12, and the inner periphery 20c of the container contact member 20 has a diameter d4 larger than the diameter d3 of the needle penetration portion 13. With this, even in cases where the needle penetration portion 13 is provided so as to project from the upper surface portion 12b of the lid portion 12, since the shape of the container contact member 20 is cylindrical and the inner periphery 20c of the container contact member 20 has a diameter d4 larger than the diameter d3 of the needle penetration portion 13, it is possible to suppress that the container contact member 20 comes into contact with the needle penetration portion 13. As a result, even in cases where the needle penetration portion 13 is provided so as to protrude from the upper surface portion 12b of the lid portion 12, the sample container 10 can be transferred while suppressing that the container contact member 20 comes into contact with the needle penetration portion 13 without exchanging the container contact member 20.

Further, in the first embodiment, as described above, the holding determination unit configured to determine whether the sample container holding unit 2 is holding the sample container 10 based on the magnitude of the negative pressure supplied to the sample container holding unit 2 is further provided. With this, it is possible to grasp whether the sample container holding unit 2 is holding the sample container 10 based on the magnitude of the negative pressure supplied to the sample container holding unit 2. As a result, for example, compared with the case of holding the sample container 10 using a magnet or the like, it can be more accurately grasped whether the sample container 10 could be held. Further, based on the number of times that the sample container holding unit 2 failed to hold the sample container 10, it is possible to grasp whether the size of the sample container holding unit 2 or the like with respect to the sample container 10 is appropriate.

Further, in the first embodiment, as described above, the notification unit 16 configured to notify that the state of the container contact member 20 is which of the first negative pressure state, the second negative pressure state, and the third negative pressure state is further provided. With this, the user can grasp the state of the container contact member 20 based on the notification content of the notification unit 16. As a result, for example, regardless of the environment in which the sample transfer device 100 is installed, it is possible to determine the replacement time based on the state of the container contact member 20, as compared with the case in which the container contact member 20 is exchanged based on the duration of use (used time) or the number of uses of the container contact member 20. Thus, the container contact member 20 can be exchanged at the timing appropriate for the environment in which the sample transfer device 100 is installed.

### Second Embodiment

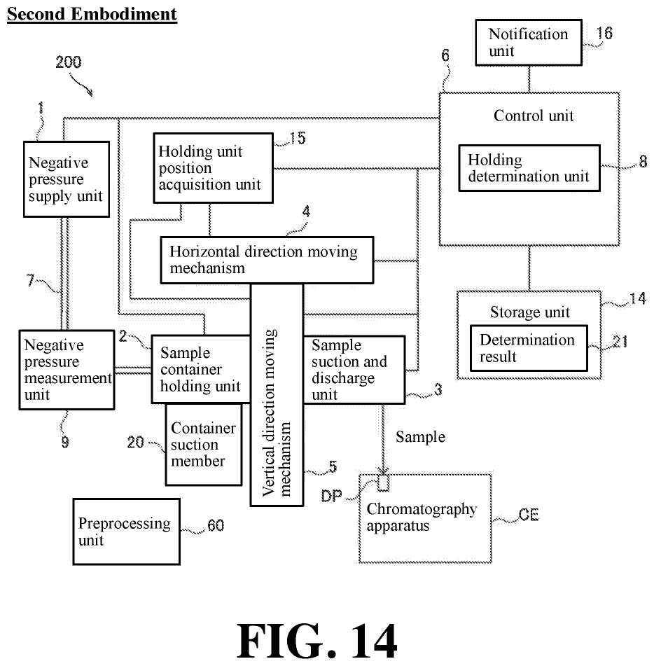

Next, with reference to FIG. 11 and FIG. 14, a sample transfer device 200 (see FIG. 14) according to a second embodiment will be described. Unlike the first embodiment in which the holding determination unit 8 determines the holding of the sample container 10, in the second embodiment, the sample transfer device 200 is provided with a holding unit position acquisition unit 15, and the holding determination unit 8 is configured to be able to determine whether the sample container 10 has been moved to a predetermined position. The same reference numerals are allotted to the same configurations as those of the first embodiment, and the description thereof will be omitted.

### Configuration of Sample Transfer Device

First, with reference to FIG. 14, the configuration of the sample transfer device 200 according to the second embodiment will be described.

In the second embodiment, in addition to the configuration of the sample transfer device 100 according to the first embodiment, the sample transfer device 200 is provided with a holding unit position acquisition unit 15 that acquires the position of the sample container holding unit 2 in the horizontal direction. Further, in this second embodiment, the holding determination unit 8 is configured to be able to determine whether the sample container 10 has been moved to a predetermined position based on the position of the sample container holding unit 2 and the magnitude of the negative pressure supplied to the sample container holding unit 2. The predetermined place denotes the preprocessing unit 60 or the second sample container placement portion 62.

The holding unit position acquisition unit 15 may have any configuration as long as it can acquire the position of the sample container holding unit 2. In the second embodiment, the holding unit position acquisition unit 15 includes, for example, a sensor for acquiring the position of the sample container holding unit 2 by the output of the motor provided in the horizontal direction moving mechanism 4.

### Movement Determination of Sample Container

In the second embodiment, the holding determination unit 8 is configured to determine whether the sample container 10 could be transferred to a predetermined position depending on whether the negative pressure value supplied to the sample container holding unit 2 is larger than the second threshold value Th2 when the sample container 10 is being transferred by the horizontal direction moving mechanism 4 and the vertical direction moving mechanism 5.

Specifically, the holding determination unit 8 determines that the sample container 10 has been transferred to a predetermined position when the value of the negative pressure supplied to the sample container holding unit 2 is larger than the second threshold value Th2 when the sample container 10 is being transferred. Further, the holding determination unit 8 determines that the sample container 10 could not be transferred to a predetermined position when the value of the negative pressure supplied to the sample container holding unit 2 is smaller than the second threshold value Th2 when the sample container 10 is being transferred.

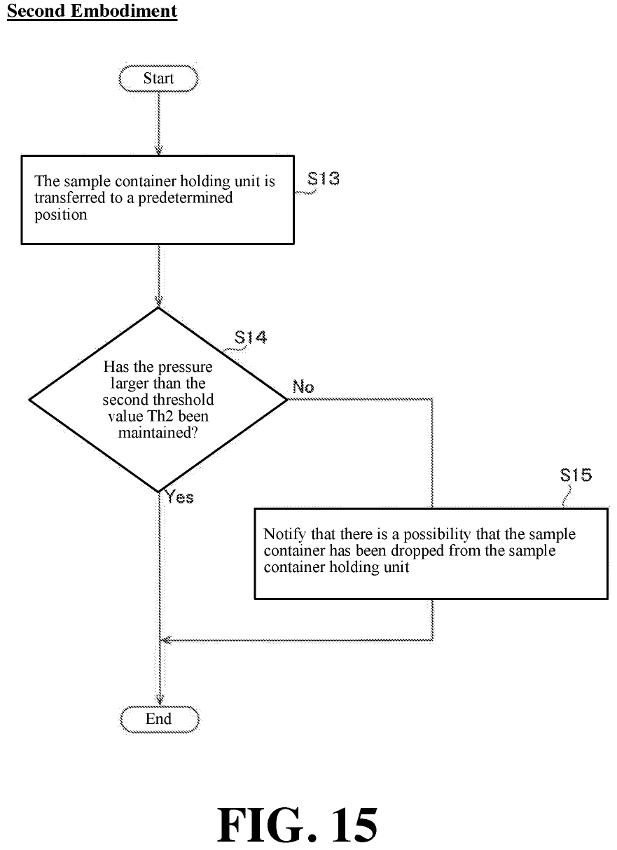

Next, with reference to FIG. 15, in the sample transfer device 200 according to the second embodiment, the flow of a method of determining whether the sample container 10 has been transferred to a predetermined position will be described.

In Step S13, the horizontal direction moving mechanism 4 and the vertical direction moving mechanism 5 transfer the sample container 10 to a predetermined position (preprocessing unit 60 or second sample container placement portion 62) under the control of the control unit 6.

Next, in Step S14, the holding determination unit 8 determines whether the negative pressure supplied to the sample container holding unit 2 is a value larger than the second threshold value Th2 when the sample container 10 is being transferred to a predetermined location. When the negative pressure supplied to the sample container holding unit 2 when transferring the sample container 10 to the predetermined location is a value larger than the second threshold value Th2, it is determined that the sample container 10 could be transferred to the predetermined location, and the determination processing is terminated. In cases where the negative pressure supplied to the sample container holding unit 2 when transferring the sample container 10 to the predetermined place is equal to or less than the second threshold value Th2, the processing proceeds to Step S15.

When the sample container 10 could be transferred to a predetermined place, the sample transfer device 200 continuously performs the subsequent processing. As the subsequent processing, for example, when the sample container 10 is transferred from the first sample container placement portion 61 to the preprocessing unit 60, the control unit 6 controls the preprocessing unit 60 to perform preprocessing of the sample. Further, for example, when the sample container 10 is transferred from the preprocessing unit 60 to the second sample container placement portion 62, the control unit 6 controls the horizontal direction moving mechanism 4 and the vertical direction moving mechanism 5 to move the sample suction and discharge unit 3 to the second sample container placement portion 62, suctions the sample from the sample container 10, and discharges the sample to the sample inlet port DP of the chromatography apparatus CE to analyze the sample.

In Step S15, the holding determination unit 8 determines that the sample container 10 could not be transferred to the predetermined location. Thereafter, the control unit 6 controls the notification unit 16 to notify that there is a possibility that the sample container 10 has been dropped from the sample container holding unit 2 and ends the processing.

The other configurations of the second embodiment are the same as those of the first embodiment.

### Effects of Second Embodiment

In the second embodiment, the following effects can be obtained.

In the second embodiment, as described above, the holding unit position acquisition unit 15 configured to acquire the position of the sample container holding unit 2 in the horizontal direction is further provided, and the holding determination unit 8 is configured to be able to determine whether the sample container 10 has been moved to a predetermined position based on the position of the sample container holding unit 2 and the magnitude of the negative pressure supplied to the sample container holding unit 2.

With this, it is possible to grasp whether the sample container 10 has moved to a predetermined place. Therefore, for example, in cases where the sample container 10 has not been transferred to the predetermined position, for example, when the sample container 10 has been dropped from the sample container holding unit 2 during the transferring, it is possible to stop suctioning the sample by the sample suction and discharge unit 3. As a result, it is possible to suppress that the sample suction and discharge unit 3 cannot suction the sample since the sample container 10 is not arranged at the predetermined position, it is possible to suppress performing the analysis without discharging the sample to the analysis device or the like.

The other effects of the second embodiment are the same as those of the first embodiment.

### Modifications

It should be understood that the embodiments disclosed here are examples in all respects and are not restrictive. The scope of the present invention is shown by the scope of the claims rather than the descriptions of the embodiments described above, and includes all changes (modifications) within the meaning of equivalent and the scope of claims.

For example, in the first and second embodiments described above, a configuration example is shown in which the sample transfer device 100 (200) includes the vertical direction moving mechanism 5 for moving the sample container holding unit 2 and the sample suction and discharge unit 3 in the vertical direction, but the present invention is not limited to this. For example, as long as it is possible to move the first sample container placement portion 61 and the second sample container placement portion 62 in the vertical direction, the sample transfer device 100 (200) may not have the vertical direction moving mechanism 5.

In the first and second embodiments, a configuration example is shown in which the sample transfer device 100 (200) is provided with the holding determination unit 8, but the present invention is not limited to this. For example, when the holding determination of the sample container 10 by the sample container holding unit 2 is not performed, it is not required that the sample transfer device 100 (200) is provided with the holding determination unit 8.

In the first and second embodiments, a configuration example is shown in which the sample container holding unit 2 and the sample suction and discharge unit 3 are arranged in different directions with respect to the second direction moving mechanism 4b in the X-direction, but the present invention is not limited to this. For example, the sample container holding unit 2 and the sample suction and discharge unit 3 may be arranged on the same direction side with respect to the second direction moving mechanism 4b in the X-direction.

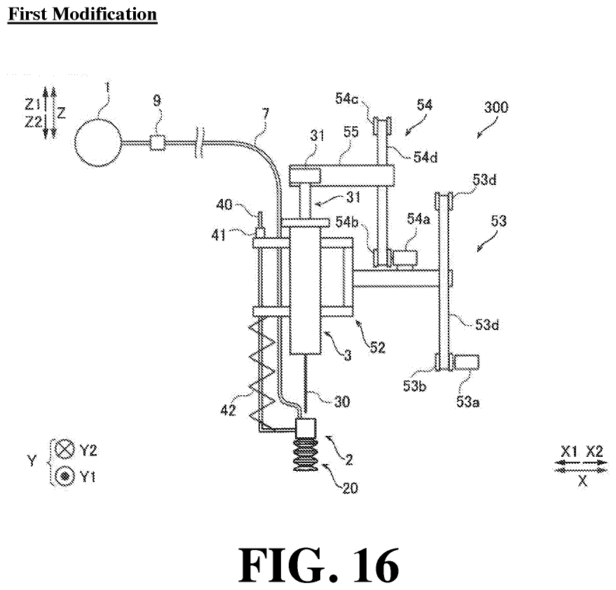

In the first and second embodiments, a configuration example is shown in which the vertical direction moving mechanism 5 independently moves the sample container holding unit 2 and the sample suction and discharge unit 3 in the vertical direction, but the present invention is limited to this. For example, like the sample transfer device 300 shown in FIG. 16, it may be configured such that the vertical direction moving mechanism 5 integrally moves the sample container holding unit 2 and the sample suction and discharge unit 3 in the vertical direction. In the case of the configuration in which the vertical direction moving mechanism 5 integrally moves the sample container holding unit 2 and the sample suction and discharge unit 3, the support portion 52 may be configured to support the sample container holding unit 2 and the sample suction and discharge unit 3.

Specifically, the support portion 52 is configured to support the support portion 40 provided with the sample container holding unit 2. Further, the support portion 40 is provided with a stopper 41 and a spring 42. When the sample suction and discharge unit 3 discharges the sample to the chromatography apparatus CE, it may be configures such that the sample container holding unit 2 (container contact member 20) is moved relative to the sample suction and discharge unit 3 in the Z-direction by the stopper 41 and the spring 42, so that the needle 30 of the sample suction and discharge unit 3 can move the inside of the sample container holding unit 2 (container contact member 20).

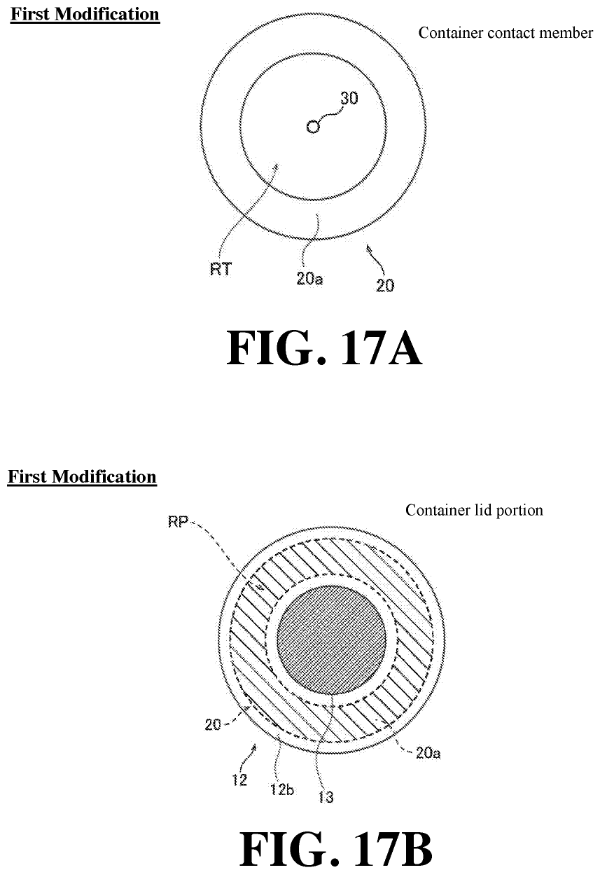

Specifically, as shown in FIG. 17A, the container contact member 20 may be configured to provide a region RT through which the needle 30 passes. By configuring as described above, when the vertical direction moving mechanism 5 is configured to integrally move the sample container holding unit 2 and the sample suction and discharge unit 3, the sample container holding unit 2 and the sample suction and discharge unit 3 can be coaxially arranged. Moreover, when coaxially arranging the sample container holding unit 2 and the sample suction and discharge unit 3, as shown in FIG. 17B, the container contact member 20 may be configured to hold the sample container 10 by supplying negative pressure in the hatched region RP of the container contact member 20.

In the first and second embodiments, a configuration example is shown in which the sample suction and discharge unit 3 discharges the sample to the chromatography apparatus CE, but the present invention is not limited to this. The apparatus by which the sample suction and discharge unit 3 discharges the sample is not limited to a chromatography apparatus CE. For example, the sample suction and discharge unit 3 may be configured to discharge the sample to an analysis device, such as, e.g., a mass spectrometer and a spectrometer. Further, the sample suction and discharge unit 3 may be configured to discharge the sample into a test tube, a plastic tube, or the like in order to adjust the sample to be analyzed.

In the first and second embodiments, the configuration example is shown in which the sample container holding unit 2 holds the sample container 10 provided with the lid portion 12 in which the needle penetration portion 13 is provided at a position recessed relative to the upper surface portion 12b of the lid portion 12, but the present invention is not limited to this. For example, the sample container holding unit 2 may be configured to hold the sample container 10 provided with the lid portion 12 in which the needle penetration portion 13 is provided so as to protrude from the upper surface portion 12b of the lid portion 12.

In the first and second embodiments, a configuration example is shown in which the sample container holding unit 2 holds the sample container 10 provided with the lid portion 12 having the needle penetration portion 13, but the present invention is not limited to this. For example, the sample container holding unit 2 may be configured to hold the sample container 10 with the lid portion 12 not having the needle penetration portion 13. Further, the sample container holding unit 2 may be configured to hold a test tube, a plastic tube, a well plate, and the like, in addition to the sample container 10.

In the first and second embodiments, a configuration example is shown in which the container contact member 20 has a cylindrical shape, but the present invention is not limited to this. As long as the container contact member 20 can come into contact with the lid portion 12 without coming into contact with the needle penetration portion 13, the container contact member 20 may have any shape.

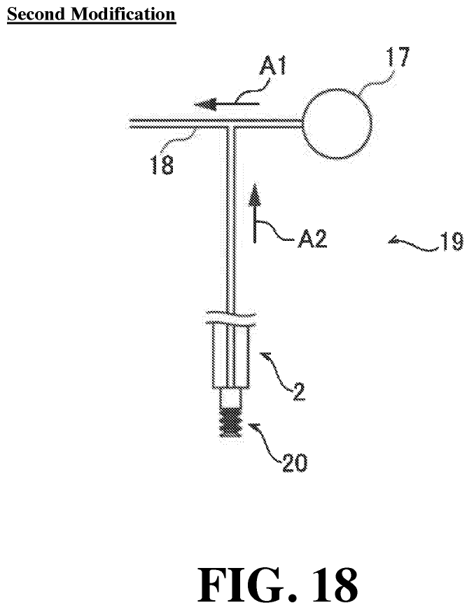

In the first and second embodiments, a configuration example is shown in which the negative pressure generated by the negative pressure supply unit 1 by suctioning air is supplied to the sample container holding unit 2, but the present invention is not limited to this. For example, as shown in FIG. 18, it may be configured to supply negative pressure to the sample container holding unit 2 by using the negative pressure supply unit 19 which generates negative pressure by discharging air. Specifically, the negative pressure supply unit 19 includes a pump 17 that discharges air (provides positive pressure) and a T-shaped tube 18. When air is discharged by the pump 17 to the T-shaped tube 18 in the arrow A1-direction, negative pressure is generated in the T-shaped tube 18 in the arrow A2-direction. Therefore, as shown in FIG. 18, by arranging the sample container holding unit 2 at a position where negative pressure is generated in the negative pressure supply unit 19, negative pressure can be supplied to the sample container holding unit 2.

In the first embodiment, a configuration example is shown in which the vertical direction moving mechanism 5 (the first vertical direction moving mechanism 5a) moves the sample container holding unit 2 in the vertical direction by a rack and pinion mechanism, but the present invention is not limited thereto. As long as it is possible to move the sample container holding unit 2 in the vertical direction, the vertical direction moving mechanism 5 (first vertical direction moving mechanism 5a) may be configured in any way. The vertical direction moving mechanism 5 (first vertical direction moving mechanism 5a) may be composed of, for example, a ball screw mechanism or a belt and pulley mechanism.

Further, in the first embodiment, a configuration example is shown in which the vertical direction moving mechanism 5 (the second vertical direction moving mechanism 5b) moves the sample suction and discharge unit 3 in the vertical direction by a belt and pulley mechanism, but the present invention is not limited thereto. As long as it is possible to move the sample suction and discharge unit 3 in the vertical direction, the vertical direction moving mechanism 5 (second vertical direction moving mechanism 5b) may be configured in any way. The vertical direction moving mechanism 5 (second vertical direction moving mechanism 5b) may be composed of, for example, a ball screw mechanism or a rack and pinion mechanism.

In the first and second embodiments, a configuration example is shown in which the sample container 10 is transferred from the first sample container placement portion 61 to the preprocessing unit 60 by the horizontal direction moving mechanism 4 and the vertical direction moving mechanism 5 in order to perform preprocessing by the preprocessing unit 60, but the present invention is not limited thereto. For example, it may be configured such that the sample transfer device 100 (200) is provided with a sample information reading unit for reading the information of the sample in the sample container 10, and the sample container 10 is transferred from the first sample container placement portion 61 to the sample information reading unit by the horizontal direction moving mechanism 4 and the vertical direction moving mechanism 5.

In the first and second embodiments, a configuration example is shown in which the sample transfer device 100 (200) transfers the sample container 10 from the first sample container placement portion 61 to the preprocessing unit 60 by the horizontal direction moving mechanism 4 and the vertical direction moving mechanism 5 to perform preprocessing of the sample, but the present invention is not limited to this. For example, it is not required to perform preprocessing of the sample, the sample transfer device 100 (200) may not have the preprocessing unit 60. When the preprocessing unit 60 is not provided, the sample transfer device 100 (200) may be configured to transfer the sample container 10 from the first sample container placement portion 61 to the second sample container placement portion 62 by the horizontal direction moving mechanism 4 and the vertical direction moving mechanism 5.

In the first and second embodiments, a configuration example is shown in which the control unit 6 performs control to determine the negative pressure state of the container contact member 20, but the present invention is not limited to this. The control unit 6 may not perform control to determine the negative pressure state of the container contact member 20.

In the first and second embodiments, a configuration example is shown in which the sample transfer device 100 (200) is provided with the notification unit 16, but the present invention is not limited to this. When it is not necessary to notify the determination result 21 of the holding determination unit 8, the sample transfer device 100 (200) may not have the notification unit 16.

1. A sample transfer device comprising:
a negative pressure supply unit configured to supply negative pressure;
a sample container holding unit configured to hold a sample container by suctioning the sample container by the negative pressure supplied in a state of being in contact with the sample container;
a sample suction and discharge unit configured to suction a sample from the sample container and discharge the sample at a predetermined position; and
a horizontal direction moving mechanism configured to integrally move the sample container holder together with the sample suction and discharge unit in a horizontal direction.

2. The sample transfer device as recited in claim 1, further comprising:
a vertical direction moving mechanism configured to independently move the sample container holding unit and the sample suction and discharge unit in a vertical direction.

3. The sample transfer device as recited in claim 1,
wherein the sample container holding unit and the sample suction and discharge unit are arranged at different positions in the horizontal direction.

4. The sample transfer device as recited in claim 1,
wherein the sample suction and discharge unit is configured to suction the sample to be analyzed by a chromatography apparatus and discharge the sample at a predetermined position of the chromatography apparatus.

5. The sample transfer device as recited in claim 1,
wherein the sample suction and discharge unit is provided with a needle for suctioning and discharging the sample,
wherein the sample container holding unit is provided with a container contact member which comes into contact with a lid portion of the sample container, and
wherein the container contact member is configured to come into contact with the lid portion without coming into contact with a needle penetration portion provided in the lid portion into which the needle is pierced when the sample suction and discharge unit suctions the sample.

6. The sample transfer device as recited in claim 5,
wherein the container contact member is configured to come into contact with the lid portion on an outer peripheral side outer than the needle penetration portion provided on an inner peripheral side of the lid portion.

7. The sample transfer device as recited in claim 6,
wherein the container contact member has a cylindrical shape,
wherein an outer periphery of the container contact member has a diameter smaller than a diameter of the lid portion, and
wherein an inner periphery of the container contact member has a diameter larger than a diameter of the needle penetration portion.

8. The sample transfer device as recited in claim 1, further comprising:
a holding determination unit configured to determine whether the sample container holding unit is holding the sample container based on magnitude of the negative pressure supplied to the sample container holding unit.

9. The sample transfer device as recited in claim 8, further comprising:
a holding unit position acquisition unit configured to acquire a position of the sample container holding unit in the horizontal direction,
wherein the holding determination unit is configured to be able to determine whether the sample container has been moved to a predetermined position based on a position of the sample container holding unit and the magnitude of the negative pressure supplied to the sample container holding unit.
